(19) United States
(12) Patent Application Publication
(10) Pub. No.: US 2008/0134818 A1
(43) Pub. Date: Jun. 12, 2008

(54) Dual-clutch transmission

(76) Inventor: Carsten Gitt, Stuttgart (DE)

Correspondence Address: KLAUS J. BACH, 4407 TWIN OAKS DRIVE, MURRYSVILLE, PA, 15668, US

(21) Appl. No.: 11/998,855

(22) Filed: Nov. 30, 2007

Related U.S. Application Data
(63) Continuation-in-part of application No. PCT/EP2006/004958, filed on May 24, 2006.

(30) Foreign Application Priority Data
Feb. 6, 2005 (DE) 10 2005 025 273.7

(51) Int. Cl. F16H 63/00; F16H 3/08

(52) U.S. Cl. 74/330

(57) ABSTRACT

In a dual-clutch transmission for a motor vehicle of four-shaft design including, for shifting into reverse gear, a shift element which connects a reverse gear drive output shaft to a reverse gear gearwheel, the shift element for the reverse gear is situated on the drive input shaft or on the drive output shaft and the shift element is usable in addition to shifting the reverse gear, for shifting also a forward gear.

This is a Continuation-In-Part Application of pending International Patent Application PCT/EP2006/604958 filed May 24, 2006 and claiming the priority of German patent application 10 2005 273.7 filed Jun. 2, 2005.

### BACKGROUND OF THE INVENTION

The invention relates to a dual-clutch transmission for a motor vehicle having two concentric inner and outer drive input shafts.

Applicants earlier patent application (P804559/DE/1 filed Mar. 17, 2004 which was unpublished at the priority date of the present application, discloses a dual-clutch transmission with four transmission shafts, in which a main transmission input shaft can be selectively placed in drive connection with two coaxial drive input shafts via a dual clutch. In forward gears, the drive input shafts drive, via gearwheel pairs, two countershafts or drive output shafts which at their end sides support gearwheels which mesh with the same drive output gearwheel of an axle differential. In order to realize a reverse gear, the patent application proposes, according to a disclosed third embodiment, to mount a loose wheel on one of the drive output shafts, which loose wheel firstly meshes with a gearwheel which is assigned to a drive input shaft, and secondly with a reverse gear wheel which can be connected by means of a shift element to a third drive output shaft. The third countershaft has a gearwheel which, in addition to the gearwheels of the other countershafts, meshes with the drive output gearwheel of the axle differential.

Further prior art is known for example from Applicants' documents DE 103 35 262 A1 and DE 103 25 647 A1.

It is the object of the present invention to provide a dual-clutch transmission which is improved with regard to
the installation space configuration,
the efficiency,
the kinetic conditions of the transmission elements, and/or
a multifunctional utilization of individual transmission elements.

### SUMMARY OF THE INVENTION

In a dual-clutch transmission for a motor vehicle of four-shaft design including, for shifting into reverse gear, a shift element which connects a reverse gear drive output shaft to a reverse gear gearwheel, the shift element for the reverse gear is situated on the drive input shaft or on the drive output shaft and the shift element is usable in addition to shifting the reverse gear, for shifting also a forward gear.

According to a first embodiment of the invention, an activation of the reverse gear takes place by means of a shift element which is assigned directly to a drive input shaft. The invention is based on the knowledge that, according to the prior art, in all gear stages which are assigned to a clutch of the dual clutch, three gearwheels of the reverse gear which mesh with one another must be moved concomitantly. Here, the central gearwheel is embodied as a loose wheel with respect to an associated countershaft or drive output shaft. For gear stages other than reverse gear, the loose wheel performs a relative movement with respect to the associated drive output shaft, which necessitates a design of the bearing arrangement of the loose wheel not only for the reverse gear but also for the forward gears. In addition, said three gearwheels constitute an inertia which is to be moved and accelerated by the drive unit and which is avoidable. By means of the direct assignment, according to the invention, of the shift element for the reverse gear to the drive input shaft, it is possible for the gearwheels interposed between the drive input shaft and the reverse gear drive output shaft to mesh with one another only when actually necessary, specifically when the reverse gear is activated. In addition, it has been proven that the arrangement of a shift element in the region of the reverse gear drive output shaft as per the prior art cited in the introduction increases the axial installation length of the reverse gear drive output shaft, which can under some circumstances be avoided by means of the assignment of the shift element to the drive input shaft.

For an alternative solution, or in addition, the gearwheel which is interposed in the reverse gear, which gearwheel is at least supported on a drive output shaft which is referred to as a further drive output shaft, can be connected to the further drive output shaft by means of a shift element. A shift element of this type can make two different shift states possible:
For an “activated” shift element, in a forward gear, the further drive output shaft drives the drive output gearwheel, so that a power flow takes place from the drive input shaft via the interposed gearwheel to the further drive output shaft.
In contrast, for the deactivated shift element, the interposed gearwheel is a loose wheel, so that said gearwheel can move freely relative to the further drive output shaft. In this case, the interposed gearwheel serves to drive the reverse gear drive output shaft which in turn drives the drive output gearwheel, in particular the differential directly. According to the invention, therefore, a double utilization of the above-mentioned shift element and of the interposed gearwheel takes place for a forward gear and for the reverse gear. A further shift element is preferably provided which selectively connects the gearwheel, which meshes with the interposed gearwheel, to the reverse gear drive output shaft.

According to one refinement of the dual-clutch transmission, the abovementioned shift element can—in addition to ensuring a first transmission ratio between a drive input shaft and the further drive output shaft and the release of the gearwheel as a loose wheel in a neutral position—in a second shift position produce a second transmission ratio between a drive input shaft and the further drive output shaft. In this way, the shift element is responsible both for two forward gears and also for a reverse gear, wherein in particular the two forward gears are assigned to one “partial transmission” of the dual-clutch transmission, that is to say for example the gear stages 1, 3, 5 or else 2, 4, 6.

In a further embodiment of the invention, the interposed gearwheel is embodied as a double gearwheel, so that said interposed gearwheel has a first gearwheel and a second gearwheel which are rotationally fixedly connected to one another and are supported with respect to the further drive input shaft. The first gearwheel meshes with a gearwheel which is assigned to a drive input shaft, so that in this way, a transmission of the power to the interposed gearwheel takes place. A transmission of the power takes place in the reverse gear via the second gearwheel which, in reverse, meshes with the gearwheel which is assigned to the reverse gear drive output shaft. In this way, the possibilities for a transmission ratio which can be realized in the reverse gear can be increased, in particular as short a transmission ratio as possible.

According to the invention, it is also possible for further gearwheels of the dual-clutch transmission to be used in a multi-functional manner. Accordingly, a gearwheel which is assigned to a drive input shaft meshes with gearwheels assigned to two different drive output shafts. By means of the gearwheels, it is possible for the drive output shafts to be selectively placed in drive connection by means of two shift elements, so that for two different gear stages, drive is provided via the gearwheel which is assigned to one of the drive input shafts.

The two different gear stages are preferably adjacent forward gears. By means of the measure according to the invention, it is possible to realize a dual-clutch transmission with a small installation size and a small number of parts. The advantages can be increased if each drive input shaft is assigned at least one gearwheel which is utilized in a dual fashion as mentioned above. It is therefore possible by means of two gearwheels which are in each case assigned to the drive input shafts to realize four forward gear stages.

Further features can be gathered from the drawing, in particular the illustrated geometries of the components, the relative dimensions of a plurality of illustrated dimensions of the same or of different components, the relative arrangement of the components with respect to one another, and their operative connections to one another. A combination of features of different embodiments which are illustrated in various figures is also possible. Further features of the invention are apparent from the illustrated wheel plans, with said features relating in particular to the selected drive connections and rigid connections of the schematically illustrated transmission elements, the arrangement of the wheels and the dimensional ratios of the illustrated transmission elements and the resulting transmission ratios.

Preferred exemplary embodiments of the dual-clutch transmission according to the invention are explained in more detail below on the basis of the accompanying drawings:

### BRIEF DESCRIPTION OF THE DRAWINGS

FIG. 1 shows a wheel plan of a first embodiment of the dual-clutch transmission according to the invention,

FIG. 2 shows a table with the shift states in the individual gear stages for the dual-clutch transmission as per FIG. 1,

FIG. 3 shows a wheel plan of a second embodiment of the dual-clutch transmission according to the invention,

FIG. 4 shows a table indicating the shift states in the individual gear stages for the dual-clutch transmission as per FIG. 3,

FIG. 5 shows a wheel plan of a third embodiment of the dual-clutch transmission according to the invention,

FIG. 6 shows a table with the shift states in the individual gear stages for the dual-clutch transmission as per FIG. 5,

FIG. 7 shows a wheel plan of a fourth embodiment of the dual-clutch transmission according to the invention,

FIG. 8 shows a table with the shift states in the individual gear stages for the dual-clutch transmission as per FIG. 7,

FIG. 9 shows a wheel plan of a fifth embodiment of the dual-clutch transmission according to the invention,

FIG. 10 shows a table with the shift states in the individual gear stages for the dual-clutch transmission as per FIG. 9,

FIG. 11 shows a wheel plan of a sixth embodiment of the dual-clutch transmission according to the invention,

FIG. 12 shows a table with the shift states in the individual gear stages for the dual-clutch transmission as per FIG. 11, and

FIG. 13 shows schematically a cross section through a dual-clutch transmission according to the invention, indicating the arrangement of three drive output shafts and drive input shafts distributed around the periphery of a drive output gearwheel.

### DESCRIPTION OF VARIOUS EMBODIMENTS

For the illustrated embodiments of a dual-clutch transmission 10 according to the invention, a transmission input shaft 11 can be selectively placed in drive connection, by means of a dual clutch 12, with a first drive input shaft 13 by means of a clutch K1 and/or with a second drive input shaft 14 by means of a clutch K2. The drive input shafts 13, 14 are arranged coaxially with respect to one another, with the drive input shaft 13 being arranged radially at the inside of the drive input shaft 14 which is a hollow shaft. The drive input shaft 14 is drive-connected to drive input gearwheels 15, 16, 17, 18 or can be placed in drive connection with the latter by means of shift elements. In the end region situated opposite from the dual clutch 12, the drive input shaft 13 projects from the drive input shaft 14, wherein in the projecting region, the drive input shaft 13 is fixedly connected to the drive input gearwheels 19, 20, and 21.

The dual-clutch transmission 10 additionally has three drive output shafts 22, 23, 24, which are arranged parallel to the drive input shafts 13, 14. The drive output shafts 23 and 24 have in each case drive output gearwheels 25-32 which are either fixedly connected to the drive output shafts 23, 24 or can be selectively connected thereto by means of shift elements. Fixedly connected to the drive output shafts 22-24 in the end region facing toward the dual clutch 12 is in each case one drive output gearwheel 33, 34, 35. The drive output gearwheels 33-35 mesh with a drive output gearwheel 36 which is embodied as a ring gear of a differential. Supported with respect to the drive output shaft 23 is the drive output gearwheel 28 which meshes with a gearwheel 37 which is drive-connected to, or can be placed in drive connection with, the reverse gear drive output shaft 22. While the drive output shafts 23, 24 are driven in each case via a gearwheel pair by the drive input shafts 13, 14 in the individual forward gear stages, power is provided for the reverse gear drive output shaft 22 by means of three gearwheels 17, 28, 37.

According to FIG. 1, the gearwheels 25, 26 can be connected by means of a shift element 38 to the drive output shaft 23, wherein
in a shift position 38-1, the drive output gearwheel 25 is connected to the drive output shaft 23,
in a shift position 38-N, the gearwheels 25, 26 are not connected to the drive output shaft 23, and
in a shift position 38-2, the drive output gearwheel 26 is connected to the drive output shaft 23.

The drive input gearwheels 16, 17 can be placed in drive connection with the drive input shaft 14 by means of a shift element 40.
In the shift position 39-1, the drive input gearwheel 16 is connected to the drive input shaft 14,
in shift position 39-N, the drive input gearwheels 16, 17 are not connected to the drive input shaft 14, and
in the shift position 39-2, the drive input gearwheel 17 is connected to the drive input shaft 14.

A shift element 40, in a left-hand shift position 40-1, connects the gearwheel 29 to the drive output shaft 24.
In a neutral position 40-N, the drive output gearwheels 29, 30 are not connected to the drive output shaft 24.
In a right-hand shift position 40-II, the drive output gearwheel 30 is connected to the drive output shaft 24.

A further shift element 41 connects,
in a left-hand shift position 41-1, the drive output gearwheel 31 to the drive output shaft 24,
in a central shift position 41-N, none of the drive output gearwheels 31, 32 to the drive output shaft 24, and
in a right-hand shift position 41-2, the drive output gearwheel 32 to the drive output shaft 24.

The further gearwheels which are illustrated and mentioned are permanently fixedly connected to the associated shafts.

According to FIG. 1, the gearwheel 28 which forms a reverse gear gearwheel is mounted, as a loose wheel, so as to be rotatable relative to the drive output shaft 23. The gearwheels 25, 21 and 29 lie in a gearwheel plane in such a way that the drive input gearwheel 21 can, depending on the shift position of the shift elements 38, 40, be utilized for driving the drive input shaft 23 or 24. For all the forward gears, the shift element 39 is in the shift position 39-1 or 39-N, so that in most of the forward gears, the gearwheels 17, 28, 37 are not moved concomitantly.

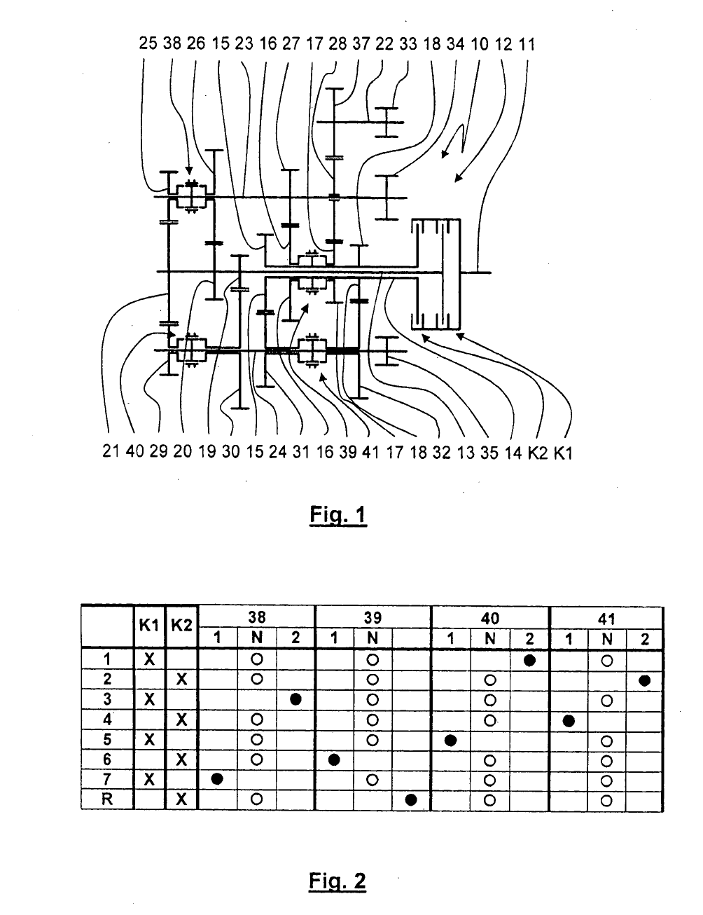

In the shift table illustrated in FIG. 2, the left-hand column illustrates the gear stage, that is to say here the forward gears 1 to 7 and a reverse gear R. Further columns illustrate the shift states for the shift elements K1, K2 and 38-41. For a person skilled in the art, it is possible to see from the shift table how the force flow in the individual forward and reverse gear stages runs in the dual-clutch transmission 10.

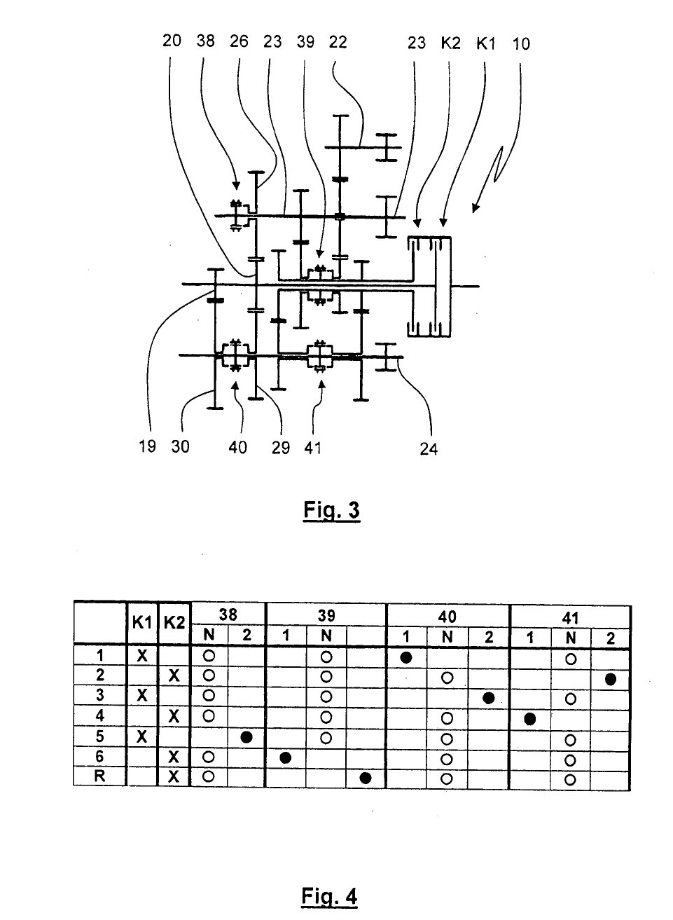

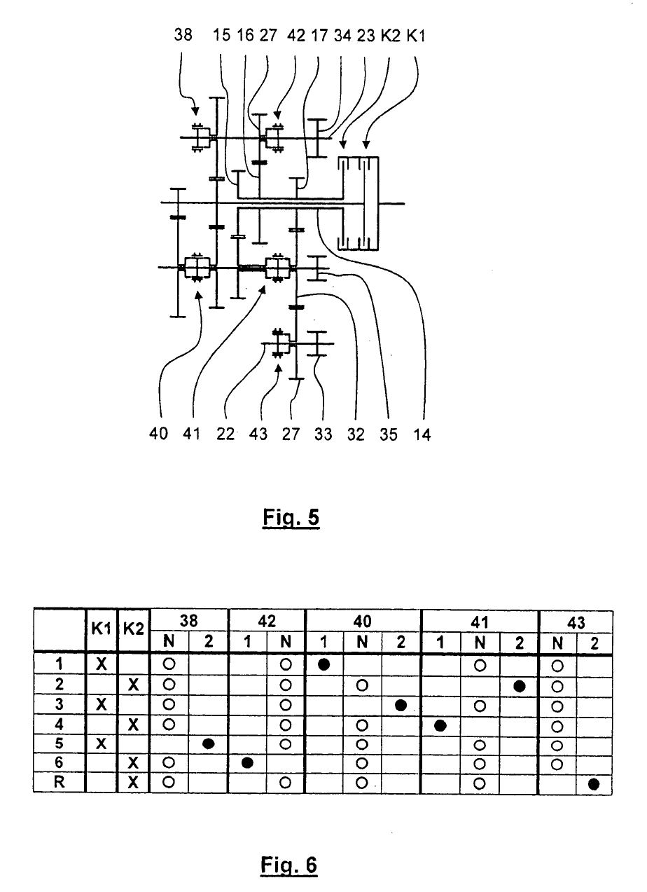

For the dual-clutch transmission 10 illustrated in FIG. 3, the shift element 38 has only a neutral position and a right-hand shift position 38-2 in which the drive output shaft 23 is rotationally fixedly connected to the drive output gearwheel 26. The gearwheel plane as per FIG. 1 with the gearwheels 25, 21 and 29 is not present in the exemplary embodiment illustrated in FIG. 3. Instead, the gearwheels 26, 20 and 29 mesh in a plane. The shift element 40 selectively connects the gearwheels 30 and 29 to the drive output shaft 24, with the gearwheel 30 meshing with the drive input gearwheel 19. The design and the force flow of the drive input shafts 13, 14 and the drive connections as per FIG. 3 additionally substantially corresponds to the embodiment as per FIG. 1.

For the exemplary embodiment illustrated in FIG. 5, in a configuration which otherwise substantially corresponds to FIG. 3. However, the shift element 39 which in FIG. 3 is assigned to the drive input shaft 14 is omitted. The drive input gearwheels 15-17 are in this case fixedly connected to the drive input shaft 14. A shift element 42, in a left-hand shift position 42-1, connects the drive output gearwheel 27 to the drive output shaft 23. The loose wheel 28 of FIG. 1 is dispensed with for the embodiment of FIG. 5. Instead, the drive output shaft with the associated transmission elements is displaced downward in the illustration as per FIG. 5, with the drive output gearwheel 27 meshing with the drive output gearwheel 32. While the drive output gearwheel 32 serves, in the shift position 41-2, to provide a drive connection in the second forward gear, the invention utilizes the fact that, in the neutral position 41-N, the drive output gearwheel 32 is a loose wheel, so that the latter serves as a through drive for the reverse gear and a direction reversal to the drive output gearwheel 27. A shift element 43, in a shift position 43-II, connects the reverse gear drive output gearwheel 27 to the drive output shaft 22.

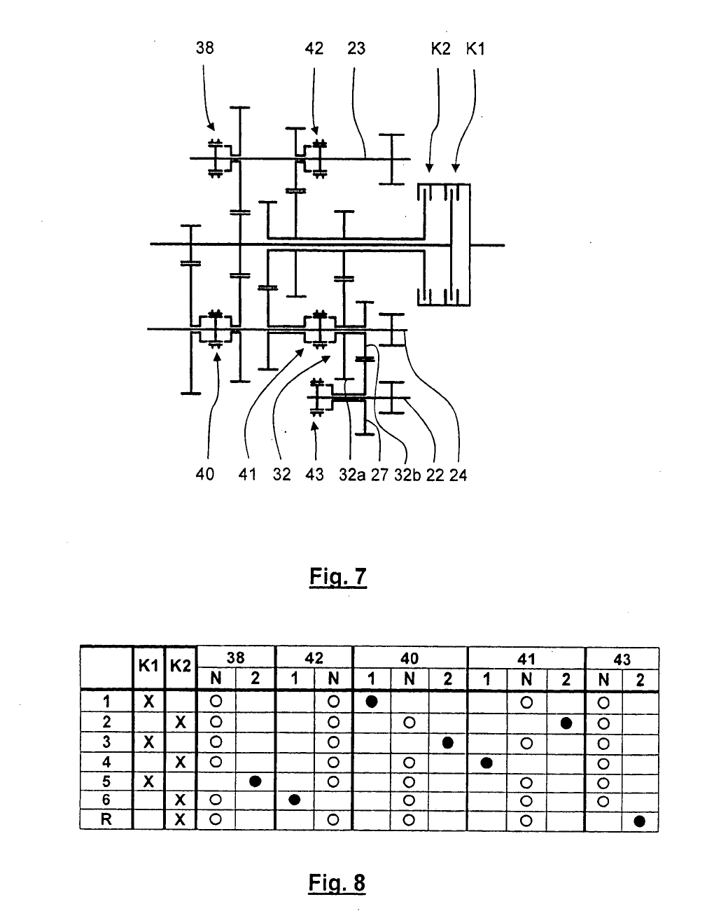

In FIG. 7, in a configuration which otherwise corresponds to FIG. 5, the drive output gearwheel 32 is embodied as a stepped gearwheel with a first gearwheel 32a and a second gearwheel 32b which are rotationally fixedly connected to one another. The gearwheel 32a is utilized in the second forward gear as a drive output gearwheel, while the gearwheel 32b is drive-connected to the reverse gear gearwheel 27. In the reverse gear wheel, with all the shift elements in the neutral position and shift element 43 in the shift position 43-2, a force flow is possible from the drive input shaft 14 to the reverse gear drive output shaft 22 via the drive input gearwheel 17, drive output gearwheel 32a, the drive output gearwheel 32b and drive output gearwheel 27.

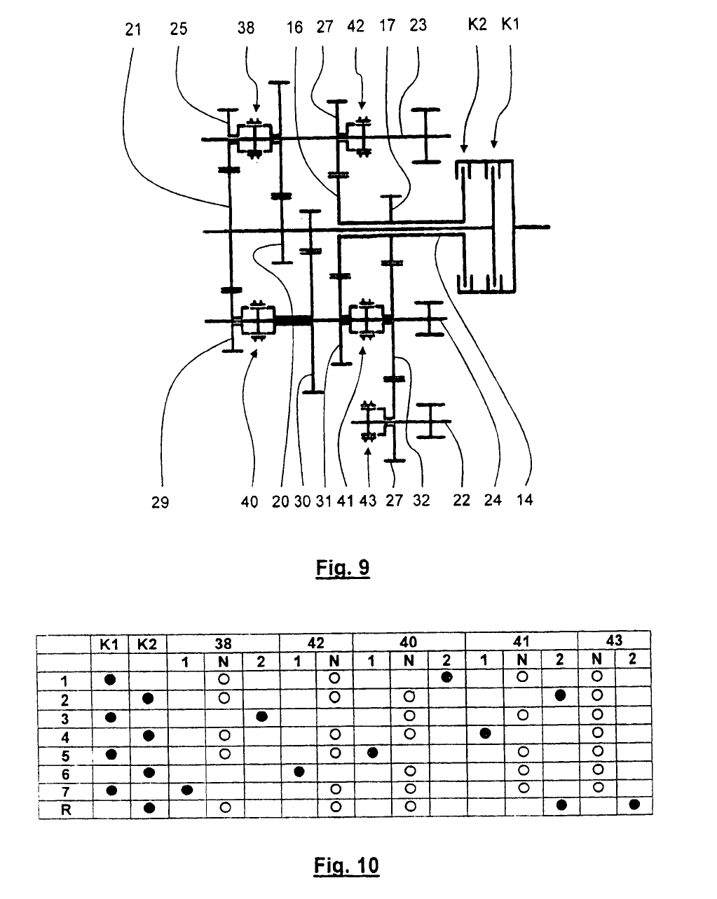

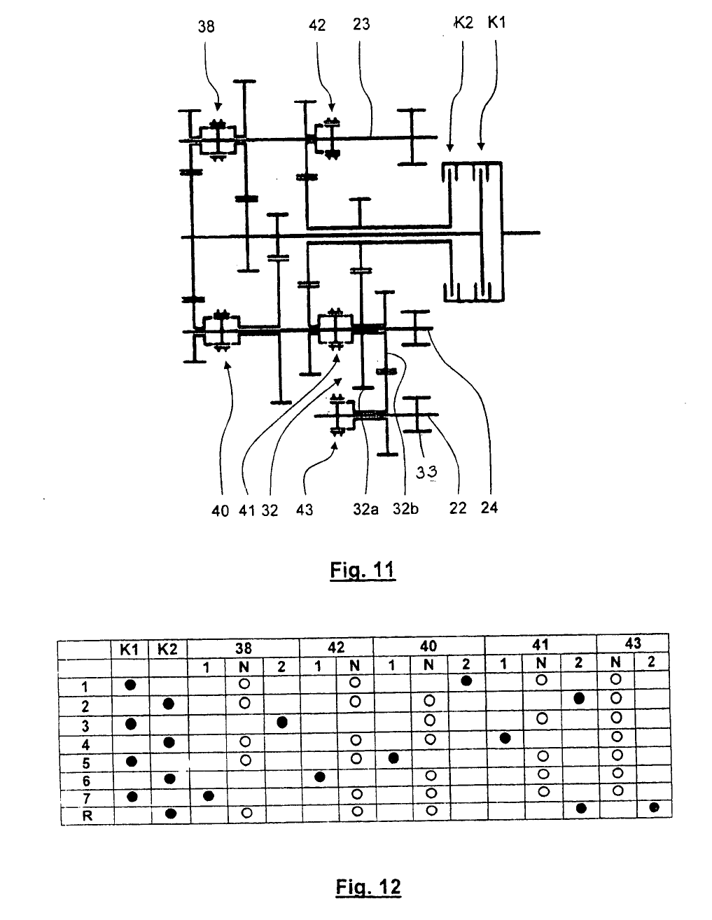

For the exemplary embodiment illustrated in FIG. 9, the drive connections for the gear stages 1, 3, 5, 7 and the shifting operation of the shift elements are of a design corresponding to that of FIG. 1. In this case, however, the drive input shaft 14, which is active for the shifted clutch K2, is provided only with two drive input gearwheels 16, 17 which are fixedly connected to the drive input shaft 14. The drive input gearwheel 16 meshes with the drive output gearwheel 27 which can be connected to the drive output shaft 23 by means of the shift element 42 in the shift position 42-1. At the same time, the drive input gearwheel 16 meshes with a drive output gearwheel 31 which can be connected to the drive output shaft 24 by means of shift element 41 in shift position 41-1. For the exemplary embodiment illustrated in FIG. 9, the realization of the reverse gear and of a drive connection to the drive output shaft 22 takes place corresponding to FIG. 5 using the shift elements 41 and 43. A force flow in the reverse gear therefore extends from the drive input shaft 14, drive input gearwheel 17, and the drive output gearwheel 32 as a loose wheel for shift element 41 in the shift position 41-N, to the drive output gearwheel 27 which is connected to the drive output shaft 22 by means of shift element 43 in shift position 43-2.

In contrast to FIG. 9, for the dual-clutch transmission as per FIG. 11, the drive output gearwheel 32 is a double gearwheel structure with two gearwheels 32a and 32b. For the case that the drive output gearwheel 32b is smaller than the drive output gearwheel 32a, it is possible to realize a particularly short transmission ratio for the reverse gear.

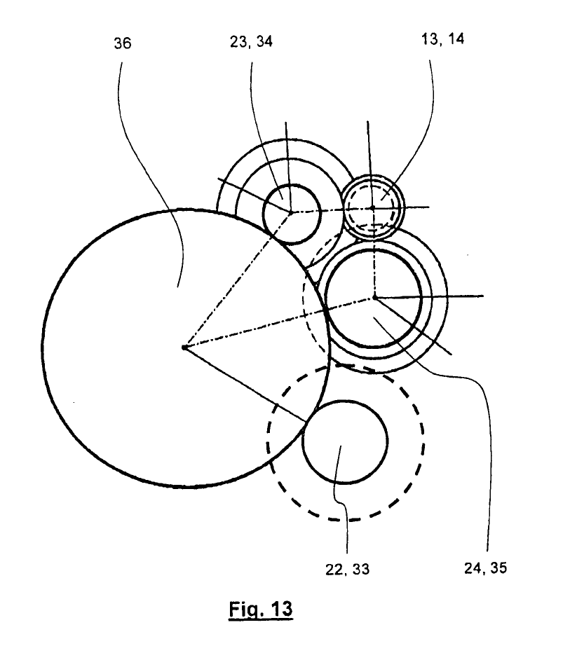

From the illustration of FIG. 13, it can be seen that the illustrated wheel plans involve a projection in one plane. The drive output shafts 22, 23, 24 are in fact arranged, as illustrated in FIG. 13, so as to be distributed in the peripheral direction around the drive output gearwheel 36 of the differential transmission gear 36, with the drive input shafts 13, 14 being arranged radially at the outside of the drive output shafts 23, 24.

The dual-clutch transmissions are used in particular as transmissions in connection with transversely mounted engines.

What is claimed is:

1. A dual-clutch transmission for a motor vehicle having two concentric inner and outer drive input shafts (13, 14) which can each be placed into the force flow between a main transmission input shaft (11) and a central drive output gearwheel (36) via a dual clutch (12), comprising
a) three drive output shafts (22, 23, 24) arranged each parallel to the drive input shafts (13, 14) and having each a gear (33, 34, 35) meshing with the central drive output gearwheel (36) and being arranged distributed peripherally around the gearwheel (36),
b) one of the drive output shafts (22, 23, 24) being a reverse gear drive output shaft (22),
c) in a reverse setting, a gearwheel (28) which is supported on a further drive output shaft (23) being interposed in the force flow between the outer drive input shaft (14) and the reverse gear drive output shaft (22),
d) the reverse gear being engageable by means of a shift element (39) disposed directly to the outer drive input shaft (14).

2. A dual-clutch transmission for a motor vehicle, having two concentric inner and outer drive input shafts (13, 14) which can each be placed into the force flow between a main transmission input shaft (11) and a central drive output gearwheel (36) via a dual clutch (12), comprising:
a) three drive output shafts (22, 23, 24), arranged each parallel to the drive input shafts (13, 14), and having each a gear (33, 34, 35) meshing with the central drive output gearwheel (36) and being arranged distributed peripherally around the gear wheel (36),
b) one of the drive output shafts (22, 23, 24) being a reverse gear drive output shaft (22), and
c) in the reverse gear, a gearwheel (32) which is supported by further drive output shaft (24) being interposed in the force flow between the outer drive input shaft (14) and the reverse gear drive output shaft (22), and
d) the gearwheel (32) which is interposed in the reverse gear being connectable by means of a shift element (41) to the further drive output shaft (24), wherein with the shift element (41) activated in a forward gear, the further drive output shaft (24) drives a drive output gearwheel (35), whereas, with the shift element (41) deactivated, the interposed gearwheel (32) is a loose wheel and the reverse gear drive output shaft (22) drives the drive output gearwheel (33).

3. The dual-clutch transmission as claimed in claim 2, wherein the shift element (41),
a) in a first shift position (41-1) of the shift element (41), a first transmission ratio between a drive input shaft (14) and the further drive output shaft (24) is established,
b) in a neutral shift position (41-N), the interposed gearwheel (32) is released to be a loose wheel for the reverse gear, and
c) in a second shift position (41-2), a second transmission ratio between a drive input shaft (14) and the further drive output shaft (24) is established.

4. The dual-clutch transmission as claimed in claim 3, wherein the interposed gearwheel (32) is a double gearwheel with a first gearwheel (32a), which meshes with a gearwheel (17) mounted on the outer drive input shaft (14), and a second gearwheel (32b) meshing with a gearwheel (27) which is supported on the reverse gear drive output shaft (22).

5. The dual-clutch transmission as claimed in claim 9, wherein the central drive output gearwheel (36) is a ring gear of a differential transmission.

6. The dual-clutch transmission as claimed in claim 2, wherein a drive gearwheel (21) which is mounted on the inner drive input shaft (13)
meshes with gearwheels (25, 29) supported on two different drive output shafts (23, 24), and
can be selectively placed in drive connection with the drive output shafts (23, 24) by means of two shift elements (38, 40),
so that for two different gear stages, a drive connection is provided via the drive gearwheel (21) mounted the drive input shaft (13).

7. The dual-clutch transmission as claimed in claim 6, wherein
each drive input shaft (13, 14) carries a drive gearwheel (21, 16), which
meshes with gearwheels (25, 29, 27, 31) assigned to two different drive output shafts (23, 24), and
can be selectively placed in drive connection with the drive output shafts (23, 24) by means of two shift elements (38, 40; 42, 41),
so that for each drive input shaft (13, 14), in two different gear stages, a drive connection is provided via the gearwheel (21, 16) which is assigned to the respective drive input shaft (13, 14).
